(19) United States
(12) Patent Application Publication
(10) Pub. No.: US 2011/0029327 A1
(43) Pub. Date: Feb. 3, 2011

(54) Medication Reconciliation System and Methods of Use

(76) Inventor: Gentry Dunlop, Aurora, CO (US)

Correspondence Address: Leyendecker & Lemire, LLC, Suite 280, 9137 E Mineral Circle, Centennial, CO, 80112, US

(21) Appl. No.: 12/511,915

(22) Filed: Jul. 29, 2009

(51) Int. Cl. G06Q 50/00; G06F 15/16

(52) U.S. Cl. 705/3; 705/2; 709/203

(57) ABSTRACT

Computer-based systems and methods are disclosed for reconciling medications at long-term care facilities. An integrated system comprises a patient care management system and a communications network for accessing third-party computer systems. The patient care management system comprises an EMR system, a medication reconciliation system, a data entry device, and one or more databases adapted to receive and store multiple patient and medical data. A computer-enabled method comprises first providing a system adapted to reconcile medications. The medication reconciliation system typically includes a server, a computer database, a data entry device, and a display. Then, the computer-enabled method comprises collecting data for a medication from the data entry device into a new medication panel repository and creating a medication line item from the information in the new medication panel repository. The medication line item can then be adjudicated by selecting one of approving, modifying, and discontinuing the medication line item.

### FIELD OF THE INVENTION

The present invention relates generally to systems and methods for the efficient administration of patient health care and electronic medical records.

### BACKGROUND

An important part of patient care in long-term care facilities is the administration of medications. Coincident with the administration of medications is the medication reconciliation process. Medication reconciliation may include processes relating to reconciliation of medications at various instances during a patient's stay, most notably during the admission, change to the level of care, or discharge processes. However, with respect to long-term care facilities, medication reconciliation is paramount during the entirety of patient's stay because a plurality of health care providers typically provides care and administers medications to a given patient. Furthermore, in the context of long-term care facilities, elderly and/or chronically ill patients require substantially more medications than patients in other types of health care settings. Hence, this many-to-many relationship between healthcare providers and patients in long-term care facilities coupled with the exacerbated medication requirements makes medication reconciliation a challenging and critical part of patient care.

Unfortunately, medical reconciliation is not dealt with at all or dealt with inefficiently at long-term care facilities. Typically, federal law generally requires that a physician must come and visit a long-term care facility on a regular basis. In a fee-for-service arrangement, the physician gets paid for the number of patients he or she sees on a regular basis. The minimum requirement for some payment systems such as Medicare is a note indicating that the physician saw documentation of the patient's condition. The physician never has to nor is he or she required to provide or review medication lists. Hence, without a system to aid the physician in reconciling medications this important function either does not get completed or it is completed in an insufficient manner. For instance, in many cases the only way to ascertain the patient's current medications is to track down a nurses' station and medication distribution information contained therein which is very time-consuming and cumbersome. Furthermore, much of the process of tracking down medications is done over the phone increasing the burden on the physician to reconcile medications and provide appropriate care to patients.

An efficient medication reconciliation process provides an important patient safety function. Absent such a medication reconciliation process, medication errors such as, but not limited to, duplications, omissions, dosing errors, and drag interactions occur frequently in a long-term care facilities. A majority of medication errors that result in injury or even death can be attributed to breakdowns in communications that could be avoided by long-term care facilities if effective medication reconciliation systems and methods were employed. For example, a first physician sees a patient and determines that the patient is depressed. Therefore, the first physician prescribes an Antidepressant A for a patient's condition. The following day prior to the arrival of Antidepressant A, a resident nurse sees the patient and also determines that the patient is depressed. Thus, the resident nurse calls an on-call healthcare provider service and asks to speak to the on-call physician. After discussing the symptoms with a second physician, the second physician concurs with the resident nurse's diagnosis and the second physician prescribes Antidepressant B. Hence, two different anti-depressants are ordered within two days and subsequently administered by another resident nurse understandably believing that there is a valid medical reason for administering both Antidepressant A and Antidepressant B to the patient. Given current regulations and standard practices the first physician may not see the patient again for another couple of months. Hence, without proper medication reconciliation processes, the patient will be on too many medications with potentially life-threatening adverse effects for a significant period of time.

Many long-term care facilities utilize conventional, paper-based systems to document the medical information of their patients. The medication reconciliation process associated with such paper-based systems typically requires vast and multi-source data aggregation to a medication list, which is prohibitively time-consuming and prone to various errors such as translation, omission, and legibility errors. Increasingly, patient health care systems comprise electronic medical records (EMR) to document important medical information. In most cases, the EMR for a patient is utilized for notes associated with the health care provider's diagnosis of the patient's medical condition. If medications are noted in a free-form text field of an EMR, that important medical information is not readily accessible or sortable to other subsequent health care providers. Therefore, even if an EMR or patient care system is employed by a long-term healthcare facility, integrated medication lists are typically not available without reentry into a specific medication tracking system.

In instances where electronic systems are employed by long-term care facilities, these systems generally focus on administrative or pharmacy needs and not the needs of the healthcare providers, particularly the attending doctors. Heretofore, the ability for healthcare providers to accurately administer medications and completely reconcile medications and treatments thereof across the continuum of care in long-term care facilities has been limited and extremely ineffective.

### SUMMARY OF THE DRAWINGS

FIG. 1 is a block diagram illustrating an exemplary architecture of a medication reconciliation system according to one embodiment

FIG. 2 is a flow chart illustrating one method for reconciling medications according to one embodiment.

FIG. 3 is a block diagram of an exemplary computer system as can be utilized in various embodiments.

FIG. 4 is an exemplary screen shot of a note builder screen according to one embodiment.

FIG. 5 is an exemplary screen shot of a medication reconciliation screen according to one embodiment.

FIG. 6 is an exemplary screen shot of a medication reconciliation screen with a new medication panel shown according to one embodiment.

FIG. 7 is an exemplary screen shot of a medication reconciliation screen during the adding of a new medication according to one embodiment.

FIG. 8 is an exemplary screen shot of an ICD-9 screen according to one embodiment.

FIG. 9 is an exemplary screen shot of a medication reconciliation screen during an adjudication and reconciliation of a new medication according to one embodiment.

FIG. 10 is an exemplary screen shot of a medication reconciliation screen displaying a current or reconciled medication and a discontinued medication according to one embodiment.

### DETAILED DESCRIPTION

Embodiments of the medication reconciliation system and methods ensure that all medications are appropriately and deliberately continued, discontinued, or modified by health care providers during the continuum of care in long-term care facilities. As part of a larger patient care management system, the medication reconciliation system utilizes various subsystems and modules to enable effective and efficient medication reconciliation processes in long-term care facilities.

Embodiments of the medication system comprise modules that work in conjunction with the EMR system. A patient's medication list is documented and actively managed electronically by a plurality of healthcare providers such as those temporarily on-site at the long-term care facility as well as the long-term facility care staff permanently on-site. Key features of the medication reconciliation system and methods of use are its simplicity of data entry and line item verification process. Given these and other features of the medication reconciliation system, busy physicians more active adopt and participate in the systems and methods of the various embodiments.

For example, a physician makes his/her rounds in a long-term care facility. It is important to note that the physician may or, as is more typical, may not be resident or based at the long-term care facility. After visiting patients, the physician uses the EMR and medication reconciliation systems to review an updated medication list on each patient visited. The physician may also review the updated medication list after each patient visit when the patient data entry computer is a laptop with wireless connectivity to the master system or a means to periodically synchronize with the master computer. The physician assures that every medication on the updated medication list has an indication and drug-drug or symptom-drug interactions have been addressed. Furthermore, the physician reviews pertinent laboratory results and additional laboratory tests are ordered as appropriate for specific medications.

Access to inclusive comprehensive medical resources for drugs, F-Tag 329 compliance issues and GDR (gradual dose reduction) requirements provides up-to-date answers for medication dosing and/or known side effects. Interdisciplinary staff notes are easily accessible and can be flagged allowing a physician to consistently comment on and/or copy pertinent information to his or her specific patient note. Following a standardized and thorough assessment of the patient, the physician can dictate his or her visit into the patient care management system of the long-term care facility. Therefore, after the physician has left the long-term care facility, a thorough and legible note is easily available for review or sharing with the interdisciplinary team or on-call healthcare providers. Furthermore, the patient's family can be electronically notified that a routine or special visit was made to their family member so that they can call the healthcare provider's office with any questions. The interfaces for communicating or messaging with the patient and the patient's family can be achieved in a multitude of well-known ways such as, but not limited to, secure email communications, web portal secured logins via the Internet, and ftp with secure file transfer software.

An important step to reducing costs and improving quality in long-term care facilities is the adoption of information technology with electronic medical records. Embodiments offer an efficient EMR system and medication reconciliation system into a complete patient care management system. Modules and interfaces allow substantive health care provider participation in the patient databases beyond what is typically provided for in similar systems focused on primarily administrative and/or pharmacy functions. Accurate and timely medication reconciliation can be performed because enhanced, multiple healthcare provider access to the EMR system, medication lists, and drug interaction databases is facilitated by the patient care management system. Hence, key medication information is placed directly in the hands of the health care provider decision-makers thereby increasing accurate and timely input with respect to a patient's medication care decisions.

Embodiments of the medication reconciliation system provide the ability to access, record, and share information providing communication among administrators and providers in long-term care facilities, various third-party entities, and a plurality of healthcare providers including a mobile physician staff. Furthermore, the medication reconciliation system takes an innovative information technology approach regulatory compliance such as, but not limited to, F-Tag 428 and F-Tag 329 compliance issues. Methods of using the medication reconciliation system enable healthcare providers and long-term care facilities to detect, monitor, and prevent adverse drug interactions particularly during the monitoring stage of medication administration process.

Thus, incorporating embodiments of the medication reconciliation systems and methods enable a long-term care facility to: (i) decrease potential liability related to medication administration process failures: (ii) increase overall regulatory compliance of the practice; (iii) ensure an HIPAA-secure patient records and related medication activity; (iv) automate and standardize quality measures in the medication administration process; (v) provide legible documentation available for use by a plurality of healthcare providers; (vi) provide greater prescriber participation in management of the medication administration process; (vii) reduce the cost associated with medication errors; (viii) reduce the administrative workload by streamlining the medication administration and reconciliation process; (ix) improve speed relating to the order of medications and the reconciliation thereof; and (x) reduce the nurse and/or pharmacist time during the admission and discharge processes.

Additionally, when embodiments of the medication reconciliation system and methods thereof are employed by a long-term care facility, a resulting added value is proved to an associated pharmacy by: (i) having regular records available via electronic interfaces; (ii) providing drug-drug, drug-laboratory, and drug-symptom cross-referencing; (iii) having more timely prescription and medication clarifications; and (iv) having laboratory prompts to enhance appropriate monitoring of potential interactions. Furthermore, when, embodiments of the medication reconciliation system and methods thereof are employed by a long-term care facility, a resulting added value is proved to healthcare providers that treat patients of the long-term care facility by: (i) decreasing potential liability related to medication administration process failures; (ii) providing more thorough patient documentation submitted by all persons providing care to the patients; (iii) providing easier access to interdisciplinary notes and medical data; (iv) increasing the decision making input particularly with respect to the medication administration process; (v) providing timely, optimized billing report data; (vi) providing Medicare compliant notes; (vii) providing inclusion of various professional resources; and (viii) providing inclusion of variance risk benefit statements.

### Terminology:

The terms and phrases as indicated in quotation marks (“ ”) in this section are intended to have the meaning ascribed to them in this Terminology section, applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to: “one embodiment”; “an embodiment”; “another embodiment”; “an alternative embodiment”; “one variation”; “a variation”; and similar phrases mean that a particular feature, structure, or characteristic described in connection with the embodiment or variation, is included in at least an embodiment or variation of the invention. The phrase “in one embodiment,” “in one variation,” or similar phrases, as used in various places in the specification, are not necessarily meant to refer to the same embodiment or the same variation.

The term “couple” or “coupled,” as used in this specification and the appended claims, refers to either an indirect or direct connection between the identified elements, components or objects. Often the manner of the coupling will be related specifically to the manner in which the two coupled elements interact

The term “long-term care facility” as used in this specification and the appended claims, refers to a wide variety of settings where healthcare services, such as but not limited to administration of medications, ambulation assistance, and/or rehabilitation therapy are performed to meet the special needs of its patients, particularly elderly patients. Examples of long-term care facilities include, but are not limited to, nursing homes, skilled nursing facilities, long-term chronic care hospitals, rehabilitation facilities, assisted living facilities, custodial care facilities, inpatient behavioral health facilities, and patients' residences when patients' are visited and care provided at their homes.

### One Embodiment of a System and Method for Medication Reconciliation in Long-term Care Facilities

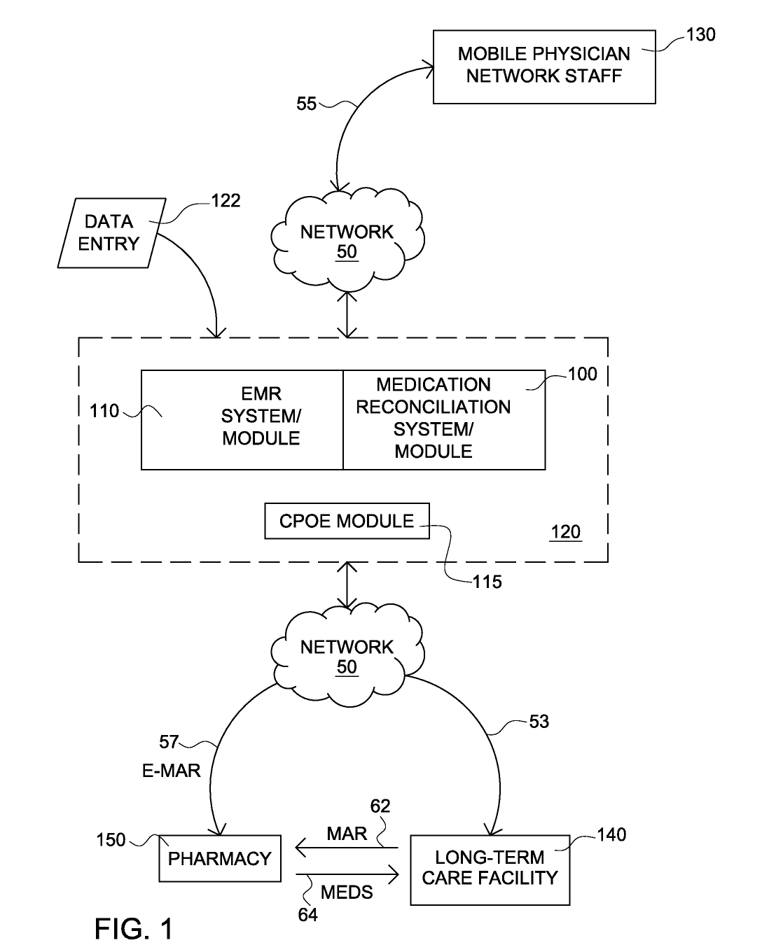

An exemplary computer-based system of one embodiment is illustrated in the block diagram of FIG. 1. For the sake of brevity, conventional data networking applications and other computer science functional embodiments of the system and components thereof may not be described in significant detail herein as would be obvious to one of ordinary skill in the art. Patient care management system 120 comprises at least one server, one or more databases, and a plurality of subsystems. A medication reconciliation system 100 for providing medication reconciliation to long-term care facilities comprises modules and interfaces to a plurality of other systems and modules of patient care management system 120. Medication reconciliation system 100 comprises various computer elements, databases, and a plurality of modules adapted to provide medication reconciliation for patients managed by patient care management system 120 such as, but not limited to, comprehensive drug interaction databases, electronic medical dictionaries, patient and physician education resource databases, F-Tag 329 compliance requirements, and GDR requirements.

In addition to the medication reconciliation system 100, patient care management system 120 includes an EMR system 110 similarly comprising modules and interfaces to a plurality of other systems and modules of the patient care management system 120. Additionally, patient care management system 120 can comprise a computerized physician order entry (CPOE) module 115 in order to facilitate computerized ordering of medications directly with a pharmacy network 150. Other similar modules and/or network interfaces may allow network connectivity to networks and computer systems Including, but not limited to, a networked computer system supporting a mobile physicians' network staff 130, and a networked computer system supporting a long-term care facility 140. For instance, the networked computer system supporting a long-term care facility 140 can comprise a nurses' station kiosk with which vital signs and other medical data is collected for a plurality of patients. The patient care management system 120, EMR system 110, and/or medication reconciliation system 100 can access via wireless communications diagnostic data collected by the nursing station kiosk. Interfacing between various systems and networks as describe above and throughout this specification is well known in the art. For instance, HL-7 (Healthcare Level 7) is a standard typically used when interfacing between various health and medical databases, however, other interfacing means are utilized and contemplated in accordance with the various embodiments.

A data entry device 122 provides a means to enter data into the patient care management system 120 and its various subsystems, particularly EMR system 110 and medication reconciliation system 100. It is pertinent to note that data entry into the patient care management system. 120 and its subsystem thereof can be received and collected from a keyboard, mouse, pen, pad, voice, touch screen, or any other way by which a user can input information into a computer system. In a variation of one embodiment, voice recognition software may be incorporated into the software of the patient care management system 120, EMR system 110, and/or medication reconciliation system 100 to increase the efficiency of the user interface or data entry device 122. Patient records entered with the data entry device 122 or transferred from another system are stored in the EMR system 110. As would be obvious to one of ordinary skill in the art, patient care management system 120 may comprise a variety of systems and components, beyond those specifically identified in FIG. 1 necessary to accomplish the complex tasks associated with managing patient care including but not limited to a display, a printer, a CD-ROM, and one or more databases.

Communications networks 50 provide connectivity between various third-party computers and networks and the patient care management system 120 and its subsystems and modules. Example computer networks 50 can include, for example, wireless networks, local and/or wide area networks, the Internet, and combinations thereof. One or more interfaces such as, but not limited to, communications ports and wireless transceivers provide the medication reconciliation system 100, EMR system 110, and/or patient care management system 120 access to the various third-party computers and networks. As mentioned above, medication reconciliation system 100 can include automated ordering of a medication directly from a pharmacy network 150 or similar medication supplier. To enable automatic ordering of medications, communication link 57 and the associated network interfaces of the pharmacy network 150 and medication reconciliation system 100 as is typically provided by CPOE module 115 can be adapted to support electronic medication administration record (e-MAR) standards and formats. Alternatively, medication ordering with the aid of medication reconciliation system 100 and patient care management system 120 may be facilitated in several ways. For instance, the networked computer system supporting the long-term care facility 140 may generate a paper medication administration record (MAR) after receiving a medication order electronically from the medication reconciliation system 100 and patient care management system 120. Then, long-term care facility staff may send or call it into the pharmacy network 150 as illustrated by arrow 62, and after proper processing through the pharmacy network 150, the pharmacy staff may mail or ship the medications to the long-term care facility.

When medication reconciliation system 100 is not located at a long-term care facility or a plurality of patient care systems are employed in the same location or setting, long-term care network 140 can be used to access medication reconciliation system 100, EMR system 110, and/or patient care management system 120 via communications link 53 and communications network 50. The networked computer system supporting the long-term care facility 140 can allow healthcare administrators, healthcare professionals, and other staff to access information on these systems. Similarly, when medication reconciliation system 100 is not physically located with a health care provider, typically the health care provider being part of a traveling or mobile network of healthcare providers providing care at a long-term care facility, the networked computer system supporting a mobile physicians network staff 130 can be used to access medication reconciliation system 100, EMR system 110, and/or patient care management system 120 via communications link 55 and communications network 50. Such remote access to the medication reconciliation system 100 is critical, for instance, when an on-call health care provider is contacted regarding a patient at long-term care facility and is required to make a medical diagnosis and/or prescribe medications.

It is pertinent to note that while the patient care management system 120, EMR system 110, and medication reconciliation system 100 shown in FIG. 1 typically employs a client/server architecture, embodiments are, of course, not limited to any particular architecture and could equally well find application in a distributed, or peer-to-peer architecture system. Moreover, as depicted in FIG. 1, some systems can be described as and their functionality can be comprised of modules, typically but not necessarily software modules, in various embodiments. For example, the medication reconciliation system 100 can also be one or more databases of a computer system comprising a medication reconciliation module, and the EMR system 110 can also be one or more databases of a computer system comprising EMR module. Such modules are adapted to provide the same functionality on a computer system as described in the context of their respective systems throughout the specification as described in.

### An Exemplary Computer System Capable of Providing Medication Reconciliation in Long-term Care Facilities

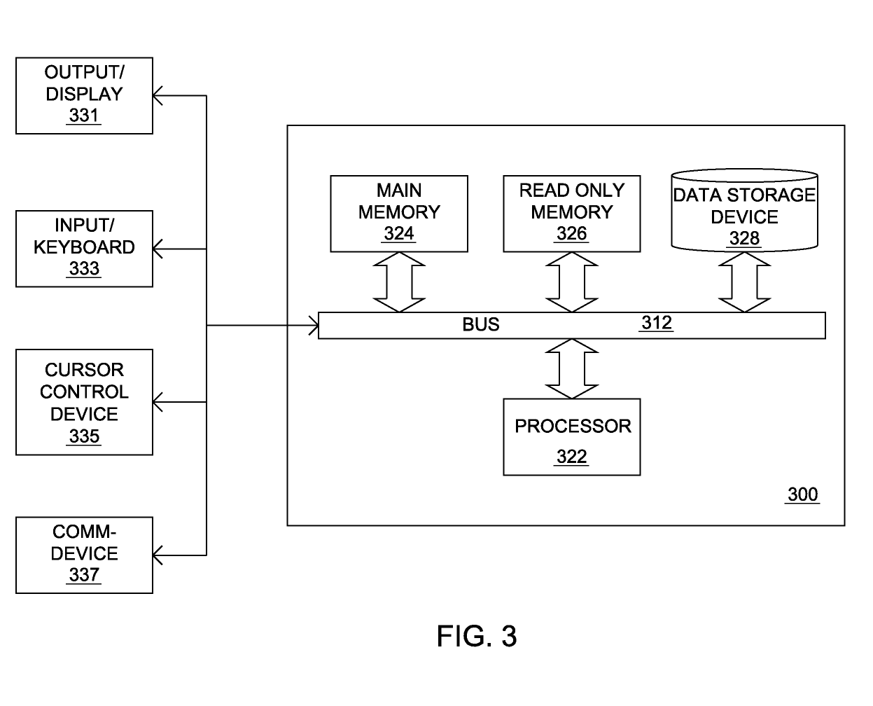

FIG. 3 illustrates an exemplary general purpose computer system upon which various embodiments can be implemented. The computer system 300 comprises a bus or other communications means 312 for communicating data or information, and a processing means such as a processor 322. The computer system 300 further comprises a random access memory (RAM) or other similar dynamically-generated storage device 324 (referred to as main memory in FIG. 3 and hereinafter). The main memory 324 is coupled to the bus 312 for storing information and instructions to be executed by the processor 322. Additionally, the main memory 324 can be used for storing temporary variables or other intermediate information during execution of instructions by the processor 322. The computer system 300 also comprises a read only memory (ROM) and/or other static storage device 326 coupled to the bus 312 for storing static information and instructions for the processor 322.

A data storage device 328 such as, but not limited to, a solid state drive or an optical disk drive can also be coupled to the bus 312 as a component of the computer system 300 for storing data and instructions. The computer system 300 can also be coupled via the bus 312 to an output or display device 331, such as but not limited to a cathode ray tube (CRT) on liquid crystal display (LCD) for displaying information to a user. Typically, an input device such as an alphanumeric keyboard 333, including alphanumeric, symbol, and other keys can be coupled to the bus 312 for communicating information and/or command selections to the processor 322. Another type of user input device is a cursor control device 335, such as a mouse, trackball, or cursor direction keys for communicating information and/or command selections to the processor 322 and for controlling cursor movement on the display 331.

The computer system 300 can also include a communications device or interface 337. Communications device 337 can be coupled to the bus 312 and allows data and software to be transferred between the computer system 300 and external networks and devices. Examples of communications device 337 can include a modem, a network interface card, a wireless network interface card, or other well-known interface device, such as those used for Ethernet, token ring, asynchronous transfer mode (ATM), or other types of physical attachment for purposes of providing a communications link to support a local or wide area network. In this manner, the computer system 300 can be coupled to a number of clients and/or servers via a conventional network infrastructure, such as and intranet and/or the Internet, for example.

It is appreciated that a lesser or more equipped computer system than the example described above may be desirable for certain implementations of the medication reconciliation system of the embodiments. Therefore, the configuration of the computer system 300 will vary from implementation to implementation depending on numerous factors such as price constraints, performance requirements, technological improvements, and/or oilier circumstances.

It is pertinent to note that, while the operation described herein can be performed under the control of a programmed processor, such as the processer 322 in FIG. 3, in alternative embodiments, the operations can be fully or partially implemented by any programmable or hard-coded logic, such as but not limited to field programmable gate arrays (FPGAs), TTL logic, application specific integrated circuits (ASICs), for example. Additionally, the method of the embodiments for providing medication reconciliation may be performed by any combination of programmed general purpose computer components and/or custom hardware components. Therefore, nothing disclosed herein should be construed as limiting the present invention to a particular embodiment wherein the recited operations are performed by a specific combination of hardware components.

As would be obvious to one skilled in the art of computer science and systems engineering, many variations and alternate embodiments of the systems described above can be used to provide medication reconciliation. The plurality of systems and modules can be stored in any one of a number of internal and external storage devices, remotely or centrally located, as those of skill in the art could easily adapt the one embodiment computer architecture to a multitude of embodiments. For example, an embodiment of the medication reconciliation system as described above can be at a different location than the patient care management system. In other embodiments, the medication reconciliation system, EMR system, and patient care management system can be wholly contained on one or more laptop computers, which one or more mobile physicians may bring with them while making patient visits at a long-term care facility. More controlled hardware and software embodiments of the medication reconciliation system may be desirable where communications networks available to long-term facilities may fail to meet Health Insurance Portability and Accountability Act of 1996 (“HIPAA”) privacy requirements and general data privacy concerns. Furthermore, a system for making, using, or selling the embodiments can be one or more processing systems including, but not limited to, servers, a central processing unit, memory, storage devices, input/output devices, communication links and devices, or any modules or components of the one or more processing system including by way of example, but not limitation, software, firmware, hardware, or any combination thereof.

### Exemplary Use of a Medication Reconciliation System in a Long-term Care Facility

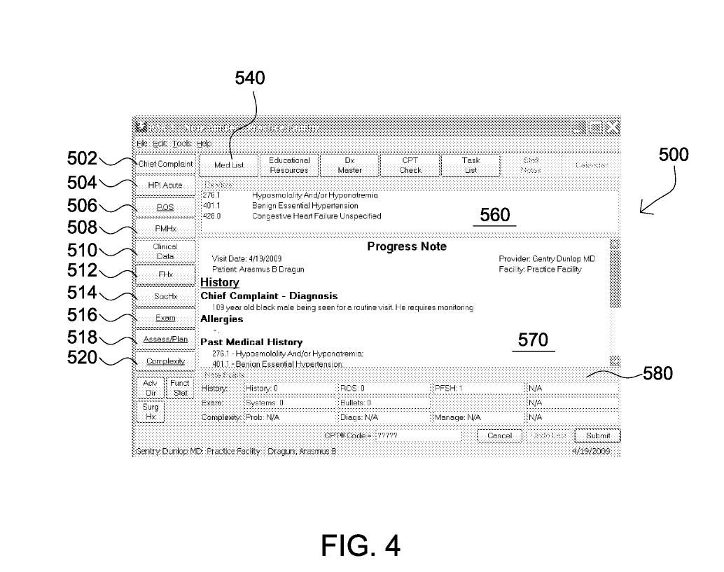

FIG. 4 is an exemplary screen shot of a note builder screen according to one embodiment. Note builder screen 500 displays three primary views as well as a plurality of buttons adapted to execute a variety of functions provided by the EMR system 110: a Dx view 560, a progress note view 570, and a note points view 580.

The Dx view 560 shows a diagnostic history for a patient record in the EMR system 110. For example, a patient may have previously been previously diagnosed and treated for congestive heart failure, benign essential hypertension, and Hyposmolality and/or Hyponatremia (a lower-than-normal level of sodium in the blood). The past and present diagnoses are summarily displayed on the Dx view 560 of the note builder screen 500 for easy viewing and access by the healthcare provider.

The progress note view 570 identifies key components of the patient visit. For example, the patient's history is typically highlighted with an emphasis on the chief complaint, any allergies, and past medical history. Additionally, other important data relating to the patients care can be indicated on the progress note view 570 such as, but not limited to, the date of the visit, the patient's name, the healthcare provider, and the facility.

The note points view 580 of the note builder screen 500 provides tallies of various actions performed relating to the patient's diagnosis, treatment plan, and history in order to aid in reimbursement justification. These note points can be presented in a quick view chart format as illustrated in FIG. 4 so that additional reference to the specific items can be made by the health care professional reviewing the EMR.

Still referring FIG. 4, several important functional buttons are identified on the note builder screen 500. A chief complaint button 502 when clicked pulls up a screen that permits the health care provider to enter the chief complaint for which the patient is being seen. An HPI Acute button 504 when clicked pulls up a screen that permits a history of the present illness for an acute condition to be entered for the chief complaint. If the chief complaint is identified as one relating to a chronic illness, an HPI Chronic button (not shown) will appear where the HPI Acute button 504 is displayed on the note builder screen 500. Similarly, the HPI Chronic button when clicked pulls up a screen that permits a history of the present illness for a chronic condition to be entered for the chief complaint. It is pertinent to note that the acute and chronic designations of the chief complaint are important to the visit because in addition to the medical treatment relevance, these designations may have an effect on billing issues related to Medicare and Medicaid.

A ROS button 506 when clicked pulls up a screen that permits the health care provider to enter a review of systems on the patient's condition. The review of system is a breakdown of the body into various medically relevant portions or systems (e.g. heart lungs, GI tract, etc.) whereby specific observations and/or answers to standard questions can be entered. The PMHx button 508 when clicked provides a display list of the patient's past medical history. Entries in the display list of the patient's past medical history can be selected or deselected for display of the progress note view 570. The Clinical Data button 510 when clicked pulls up a screen that permits entry of the patient's vital signs and other clinical data taken during the visit including, by way of example but not limitation, blood pressure, heart rate, temperature, weight allergies, and immunization.

The patient's family and social history can be entered into the EMR system 110 via an FHx button 512 and a SocHx 514 button when clicked, respectively. Family history may contain relevant medical history of the patient's immediate family members to identify any potential genetic disposition or risk to common disease such as coronary diabetes or heart disease. Social history may contain historical information relevant to the patient's health such as, but not limited to, whether the patient smokes tobacco or uses alcohol. An Exam button 516 when clicked pulls up a screen that permits the health care provider to enter a current examination for the visit into the EMR system 110. An Assess/Plan button 518 when clicked pulls up a screen that permits the health care provider to enter a current assessment and treatment plan for the patient to correct the identified illness or illnesses. A Complexity button 520 when clicked pulls up a screen that permits entry of the complexity level associated with the health care provider's visit. Similar to the history of the present illness for an acute or chronic condition discussed above, the complexity identified for a patient visit is relevant and required for certain Medicare and Medicaid compliance and billing issues. Still referring to FIG. 4, a Med List button 540 of the note builder screen 500 when clicked opens a medication reconciliation screen in the EMR system 110.

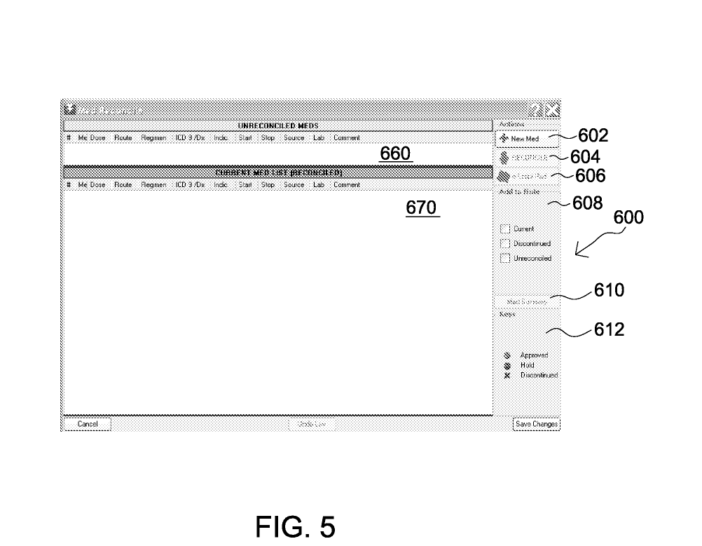

FIG. 5 is an exemplary screen shot of a medication reconciliation screen according to one embodiment of the present invention. Illustrated on medication reconciliation screen 600 is an UNRECONCILED MEDS section 660 and a CURRENT MED LIST (RECONCILED) section 670. Upon initial activation of die medication reconciliation screen 600, only the UNRECONCILED MEDS section 660 and the CURRENT MED LIST (RECONCILED) section 670 are displayed whereas a section identifying discontinued medications (described later in the specification) is minimized at the bottom. However, the section identifying discontinued medications can be resized as needed or with the appropriate data entry to that section of the medication reconciliation screen 600.

The UNRECONCILED MEDS section 660 displays medication line items after creation and essentially serves as a staging area for the medication line items. Further, any medication for which a healthcare provider has no knowledge typically is first entered into this unreconciled medication list as provided by the UNRECONCILED MEDS section 660. The CURRENT MED LIST (RECONCILED) section 670 identifies the patient's complete list of reconciled medications and Is an account of all medications that are being administered to the patient. Further identified on the medication reconciliation screen 600 is a New Med button 602, a RECONCILE button 604, an eScript Pad button 606, an Add to Note checkbox area 608, a Med Summary button 610, and a Keys area 612.

Still referring to FIG. 5, the New Med button 602 opens an area in the medication reconciliation screen 600 from which a new medication line item can be created. The RECONCILE button 604 reconciles medication line items from one section of the medication reconciliation screen 600 to another. The eScript Pad button 606 opens an electronic script pad repository from which medication may be ordered directly from a linked pharmacy network. Referring briefly back to FIG. 1, when the eScript Pad button 606 evokes the automatic ordering of medications function medication reconciliation system 100 utilizes CPEO module 115 to access and communicate with pharmacy network 150 via communications link 57 and communication network 50. Further, these system and network components utilized to enable automatic ordering of medications can be adapted to support e-MAR standards and formats. The Add to Note checkbox area 608 when clicked permits the healthcare provider to add specific line item display sections onto the healthcare provider's progress note view 570 (as shown in FIG. 4). The Med Summary button 610 provides a summary of all the medication line items contained within the medication reconciliation screen 600 available for print and/or electronic distribution. The Keys area 612 is simply a legend identifying “Approved, Discontinued, and Discontinued” symbols for use with medication line items of the medication reconciliation screen 600.

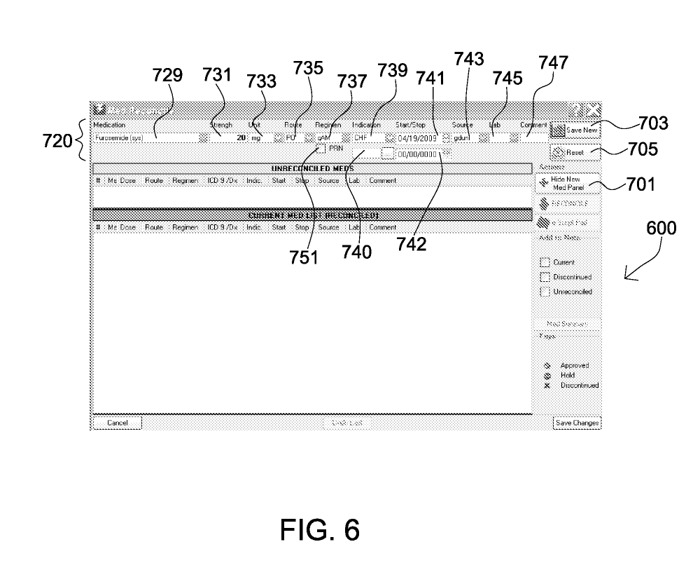

Exemplary medication reconciliation system 100 is shown and described with reference to FIGS. 1, 6 through 10. FIG. 6 is an exemplary screen shot of medication reconciliation screen 600 with a new medication panel shown according to one embodiment. After New Med button 602 has been selected, a new medication panel 720 appears in the top area of the medication reconciliation screen 600. The new medication panel 720 typically comprises data entry fields including, but not limited to, medication name 729, strength 731, unit 733, route 735, regimen 737, PRN selector 751, a first indication 739, a second indication 740, start date 741, stop date 742, source 743, lab 745, and comment 747. The medication name 729 can be selected from a dropdown library of medications or can be entered as free-form text. The strength 731 represents a dosage amount being recommended in conjunction with the corresponding unit 733 (e.g., mg). The route 735 refers to the method of administering the medication such as, but not limited to, by injection, orally, by inhaler, etc. The regimen 737 indicates how often a medication should be taken, whereas if the PRN selector 751 has been selected, then the health care provider is indicating that the medication should be taken “as needed” by the patient.

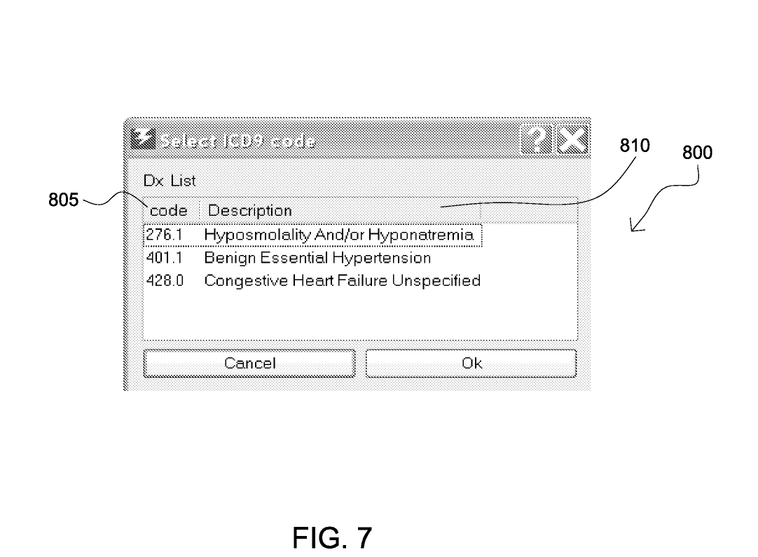

The first indication 739 is a primary indication referring to the type of illness being treated and/or system of the body for which the medication is intended. The first indication 739 can be selected from a dropdown list of indication codes or can be entered as free-form text Examples of the first indication 739 include, but are not limited to, indication codes representing psychiatric, cardiovascular, allergic, respiratory, gastrointestinal, and neurological. Alternatively, the second indication 740 can be used as the primary indication referring to the type of illness being treated and/or system of the body for which the medication is intended. Upon selecting the second indication 740, an ICD-9 screen 800 appears as illustrated in FIG. 7. The ICD-9 screen 800 displays a code 805, represented typically by numeric values, and a description 810 from the patient's ICD-9 diagnosis list (see the Dx view 560 of note builder screen 500 from FIG. 4). As appearing in one embodiment, ICD-9 codes refer to the International Classification of Diseases, 9th Revision, however, any future revision or similar indication listing may be substituted in accordance with the embodiments. It is pertinent to note that indications and ICD-9 codes are increasingly seen by regulatory surveyors as required inclusion in patient care documentation.

Referring back to FIG. 6, the start date 741 indicates date when the medication should be started and the stop date 742 indicates when the medication should be stopped. The source 743 identifies the health care provider entering the data and/or authorizing the medication. The lab 745 indicates suggested laboratory test that are or will be required prior to, during, or after the administration of the medication. The comment 747 when clicked permits any comments to be entered into the new medication panel 720. If the healthcare provider wished to clear all fields of the new medication panel 720, a Reset button 705 can be selected to do so. It is worthy to note that some of the data entry fields in the new medication panel 720 will be required while others will be optional. In one embodiment the medication name 729, strength 731, unit 733, source 743, and one of the first indication 739 and the second indication 740 data entry fields are required, while the route 735, regimen 737, PRN selector 751, start date 741, stop date 742, lab 745, and comment 747 are optional.

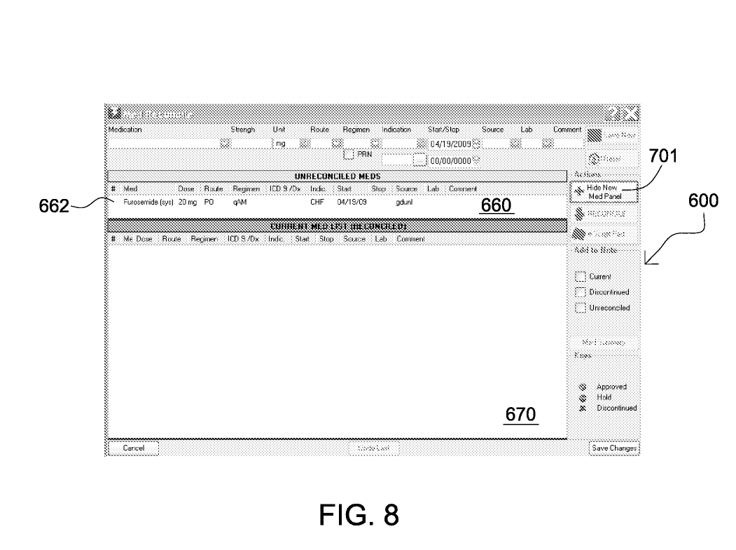

Upon entering data into the required fields of the new medication, panel 720, a Save New button 703 will be enabled for selection by the health care provider entering data. When the Save New button 703 is selected, the medication reconciliation system 100 saves and transforms the recommended medication information into a medication line item. As depicted in FIG. 8, after the Save New button 703 has been selected, a first medication line item 662 is displayed on the UNRECONCILED MEDS section 660. A Hide New Med Panel button 701 can be selected to hide the new medication panel 720 within the medication reconciliation screen 600 if no additional medications are to be entered into medication reconciliation system 100 at that particular time. As previously described, the UNRECONCILED MEDS section 660 displays medication line items after creation and essentially serves as a staging area for the medication line items. Hence, the first medication line item 662 can be reviewed for accuracy and completeness prior to proceeding. The healthcare professional can select the first medication line item 662 for adjudication and reconciliation by clicking on it.

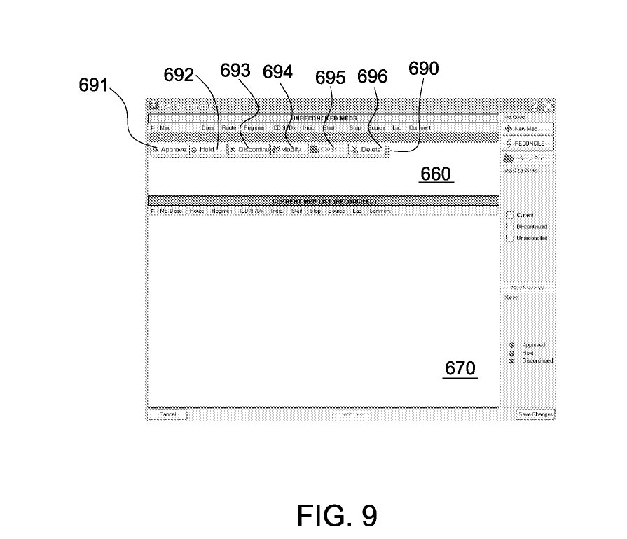

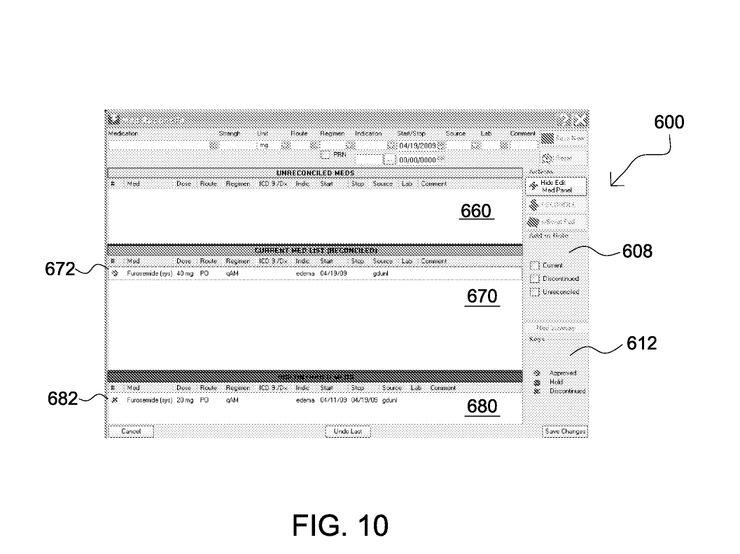

FIG. 9 is an exemplary screen shot of a medication reconciliation screen during an adjudication and reconciliation of the first medication line item 662 according to one embodiment. Upon selecting the first medication line item 662, a status bar 690 used to adjudicate medication line items can be displayed in the UNRECONCILED MEDS section 660. It is important to note that each medication line item must be adjudicated individually with a specific status from the status bar 690 before it can be reconciled into the CURRENT MED LIST (RECONCILED) section 670. The status bar 690 is an interactive display including, but is not limited to, an Approve button 691, Hold button 692, Discontinue button 693. Modify button 694, Clear button 695, and Delete button 696. The Approve button 691 applies an “approved” status to the medication line item and sends it to the CURRENT MED LIST (RECONCILED) section 670. The Hold button 692 applies a “hold” status to the medication line item and sends it to the CURRENT MED LIST (RECONCILED) section 670. The Modify button 694 sends the medication line item back to the new medication panel 720 for the required modifications. The Clear button 695 clears the line item of any applied status. The Delete button 696 deletes the entire medication line item. The Discontinue button 693 applies a “discontinued” status to the medication line item and sends it to a DISCONTINUED MEDS section 680 as illustrated in FIG. 10.

Referring to FIG. 10, a second medication line item 672 can be displayed in the CURRENT MED LIST (RECONCILED) section 670. The second medication line item 672 is an example of an approved medication line item as indicated by identification of the associated symbol in the Keys area 612. Additionally, the second medication line item 672 can be displayed on the note builder screen 500 by selecting “Current” in the Add to Note checkbox area 608. A third medication line item 682 can be displayed on the DISCONTINUED MEDS section 680. The third medication line item 682 is an example of a discontinued medication line item as indicated both by identification of the associated symbol and its placement in the medication reconciliation screen 600. Similarly, the third medication line item 682 can be displayed on the note builder screen 500 by selecting “Discontinued” in the Add to Note checkbox area 608. Although no unreconciled medication line items are shown in FIG. 10, any unreconciled medication line items can also be displayed on the note builder screen 500 by selecting “Unreconciled” in the Add to Note checkbox area 608.

It should be noted that embodiments include functions and data relating to the patient care management and EMR systems integrated with the medication reconciliation system beyond the views, fields, and buttons described above and as shown on the exemplary screen shots.

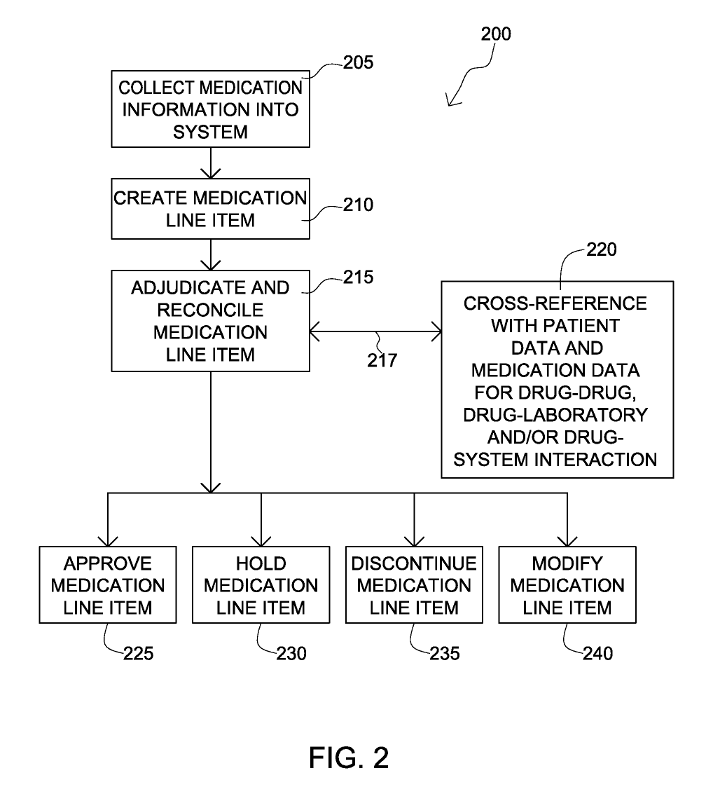

A method 200 of using medication reconciliation system 100 according to the embodiments to reduce medication errors such as, but not limited to, duplications, omissions, dosing errors, and drug interactions is illustrated with reference to FIG. 2. The method 200 can be used at various times during a patient's continuum of care. This includes when a patient is admitted to a long-term care facility, when the patient is discharged from the long-term care facility, and during the extended slay of die patient at the long-term care facility. Importantly to long-term care facilities, changes, additions, and deletions in prescribed medications occur frequently during the patient's stay at the long-term care facility. For instance, a plurality of medications may be prescribed and/or administered by healthcare providers in conjunction with various outpatient visits.

The method 200 includes an operation 205 of collecting data entered by a user into the medication reconciliation system 100 (FIG. 1) after a diagnosis of a patient has been conducted. The user entering medication information may be any of a variety of persons such as, but not limited to, long-term care facility staff personnel, physicians, or other healthcare providers. In certain long-term care facility settings, like home health care settings for instance, no medical chart or record typically exists. In other long-term care facility settings, like nursing homes, some sort of medical chart or record may already exist. However, the existing medical chart or record typically comprises different and/or missing information than that which is required for a visiting physician to provide appropriate patient care and the treatment of the patient's illnesses with medications. Hence, patient notes and patient medical data are typically collected and created on the medication reconciliation system 100 itself and/or in conjunction with EMR system 110 and patient care management system 120.

Another operation 210 includes creating a medication line item in the medication reconciliation system 100 (FIG. 1). The medication line item can include medication information related to the recommended administration of the medication such as, but not limited to, the medication name 729, strength 731, unit 733, route 735, regimen 737, PRN selector 751, a first indication 739, a second indication 740, start date 741, stop date 742, source 743, lab 745, and comment 747 (FIG. 6). This operation ensures that when a new medication is added to the patient's record it first goes to the UNRECONCILED MEDS section 660 (FIG. 8) of the medication reconciliation system 100. Hence, when the user is considering about putting the patient on a particular medication, the medication, remains part of an unreconciled list until it is accepted by the user after obtaining additional information or by another user (for example a physician or other healthcare professional with approval authority) and added to the patient's current medication list.

Next, an operation 215 includes adjudicating and reconciling the medication line item. First, acknowledging and adjudicating the medication line item can include actively reviewing it for accuracy and completeness with the aid of the status bar 690 (FIG. 9). The status bar 690 can include, but is not limited to, the Approve button 691, Hold button 692, Discontinue button 693, Modify button 694, Clear button 695, and Delete button 696. Further, medication reconciliation system 100 can include cross-referencing the medication line item with patient data and medication data for potential drug-drug, drug-laboratory, and/or drug-system interactions (block 220).

Relevant information regarding potential drug-drug, drug-laboratory, and/or drug-system interactions can be fed back to the medication reconciliation screen 600 (FIG. 10) as shown by feedback loop 217. With the medication reconciliation system 100 (FIG. 1) described herein, a physician or healthcare professional can more readily assess drug-to-drug interactions and drug-to-disease interactions among other consequences with administering a new medication. For example, if the patient has ulcers, it would be detrimental to this condition to additionally prescribe non-steroidal medications, which can promote more ulcers. The medication reconciliation system 100 will provide this medical reconciliation function and provide the user or users with the appropriate information upon cross-referencing the patient and medication data with various databases. It is worthy to note that other isolate, parallel systems and long-term care facility processes do not address this drug-to-drug and drug-to-disease interactions while creating a patient record or prescribing a new medication.

Still referring to FIG. 2, one or more of the following operations in blocks 225, 230, 235, and 240 can be performed next in accordance with the method 200 of the embodiments. As indicated in block 225, the medication line item can be approved by selecting the Approve button 691 on status bar 690 (FIG. 9) of the medication reconciliation system 100 (FIG. 1). The medication line item will then be moved from the UNRECONCILED MEDS section 660 to the CURRENT MED LIST (RECONCILED) section 670 (FIG. 10). The medication line item can also be put on hold (block 230) by selecting the Hold button 692 on status bar 690 (FIG. 9). The hold operation of the method 200 places the medication line item in the CURRENT MED LIST (RECONCILED) section 670 from an active status to a hold status within that same section of the medication reconciliation screen 600 (FIG. 10). Also, as indicated in block 240, the medication line item can be modified in any number of ways. By selecting the Modify button 694 (FIG. 9), the medication line item is typically sent back to the new medication panel 720 for the required modifications (FIG. 6). For example, the user may wish reduce the dosage of a current medication by changing its strength 731 and/or regimen 737 of the medication line item. As previously noted. GDR (gradual dose reduction) requirements information can be accessed via the medication reconciliation system 100 should the user wish to consult such available reference materials. The user can also discontinue a medication line item (block 235) by selecting the Discontinue button 693 of the status bar 690 (FIG. 9) thereby applying a “discontinued” status to the medication line item and sending it to the DISCONTINUED MEDS section 680 of the medication reconciliation screen 600. It is pertinent to note that the discontinued medication line item may remain on the DISCONTINUED MEDS section 680 indefinitely as it is helpful for the users of the medication reconciliation system 100 to see that the medication was discontinued, and if it is very important that the discontinued medication line items be readily identified, the user may displayed it on the note builder screen 500 (FIG. 4) by selecting “Discontinued” in the Add to Note checkbox area 608 (FIG. 10). Further, if the medication line item is discontinued and moved from the CURRENT MED LIST (RECONCILED) section 670 to the DISCONTINUED MEDS section 680, the medication reconciliation system 100 can generate a cancelled prescription message to the pharmacy network 150 (FIG. 1) instructing the pharmacy to discontinue supplying that specific medication to the patient.

By performing the method 200 described above enabled by the medication reconciliation system 100 (FIG. 1), physicians and other health care providers have immediate access to past and present medication reconciliation information and can make appropriate medication decisions even if they do not see the patient frequently and/or may not be present on the site or long-term care facility. Hence, every physician and other health care provider that comes through and provides care to the long-term care facility can use the medication reconciliation system 100 thereby incorporating the medication reconciliation process as part of the overall health care management.

### Alternate Embodiments and Variations

Alternate embodiments and variations thereof described above are merely exemplary and are not meant to limit the scope of the present invention. It is to be appreciated that numerous alternate embodiments and variations to the system and method described herein have been contemplated as would be obvious to one of ordinary skill in the art with the benefit of this disclosure.

Consequently, the methods of the embodiments can be implemented: as a sequence of computer-implemented operations running on the system; and/or as interconnected modules within the system. The methods of the embodiments can be implemented on a special purpose computer, a general purpose computer programmed with software designed to execute the processes described herein, and/or a computer-readable storage medium. Furthermore, it is understood that embodiments are not limited with regard to any particular network environment or the application used to communicate in that environment. The implementation of the systems and methods of the medication reconciliation system is a matter of choice dependent on the particular performance requirements of the system implementing methods of various embodiments as well as the computer and networking resources available in a given scenario.

It will be recognized by one of ordinary skill in the art that the operations and modules can be implemented in software, and firmware, in special-purpose digital logic, analog circuits, and any combination thereof without deviating from the spirit and scope of the embodiments as recited within the claims attached hereto. All variations of the invention that read upon the appended claims are intended and contemplated to be within the scope of the embodiments of the present invention.

I claim:

1. An integrated system residing on one or more computer systems, the integrated system comprising:
a patient care management system, the patient care management system comprising,
an electronic medical records (EMR) system,
a medication reconciliation system,
a data entry device, and
one or more databases adapted to receive and store patient and medical data;
wherein the medication reconciliation system is adapted to (i) receive a patient record from the EMR system, (ii) create a medication line item against the patient record, and (iii) allow the medication line item to be placed in one of an unreconciled medication display image, a reconciled medication display image, and a discontinued medication display image.

2. The integrated system of claim 1, further comprising one or more interfaces to at least one communications network.

3. The integrated system of claim 2, further comprising:
a computerized physician order entry (CPOE) module, the CPOE module residing in the
patient care management system; and
wherein at least one of the one or more interfaces connects to a pharmacy network, the pharmacy network being in communications with the patient care management system, and the patient care management system being adapted to receive electronic medication administration records from the pharmacy network.

4. The integrated system of claim 2, further comprising a computer system supporting one of a long-term care facility and a mobile physicians' network.

5. The integrated system of claim 2, wherein the medication reconciliation system is further adapted to: (iv) display the medication line item and a symbol indicating one of an approved, a hold, and a discontinued status on the patient record.

6. A computer system for reconciling medications, the computer system comprising:
a server computer, the server computer having,
a processor,
a network connection coupled to the processor, and
one or more storage devices coupled to the processor, the one or more storage devices having stored thereon machine-readable instructions, the instructions when executed by the processor causing the processor to,
access a medication reconciliation module in the one or more storage devices when the processor receives a request for a medication list via the network connection, the request for the medication list including at least one identifier referencing a patient record for the medication list received from the data entry device, and
access at least one of (i) an unreconciled medication data list, (ii) a reconciled medication data list and (iii) a discontinued medication data list in the one or more storage devices for the patient record.

7. The computer system of claim 6, the machine-readable instructions when executed by the processor causing the processor to further;
access an EMR module in the one or more storage devices and create a new medication line item in die one or more storage devices via die network connection when die processor receives a request to save new medication.

8. The computer system of claim 7, the machine-readable instructions when executed by the processor causing the processor to further:
access a CPOE module in the one or more storage devices and generate an electronic script pad repository for ordering medications via the network connection when the processor identifies a request to order a medication represented by the new medication line item.

9. The computer system of claim 6, the machine-readable instructions when executed by the processor causing the processor to further:
generate an interactive status bar display for one of approving, holding, discontinuing, modifying, clearing, and deleting a one of at least one medication line item via the network connection when the processor receives a request for the interactive status bar display.

10. The computer system of claim 9, the machine-readable instructions when executed by the processor causing the processor to further:
access family and social history data in the one or more storage devices, and generate a medication interaction display comprising the family and social history data and the one of at least one existing medication line item when the processor receives a request to approve the one of at least one medication line item from the unreconciled medication data list and move it to the reconciled medication data list.

11. A computer-enabled method comprising:
providing a computer system adapted to reconcile medications, the computer system comprising a server, a computer database, a data entry device, and a display;
collecting data for a medication entered into a new medication panel repository;
creating a medication line item from the data collected in the new medication panel repository;
storing the medication line item in the computer database;
moving the medication line item into an unreconciled medication section display; and
adjudicating the medication line item by selecting one of approving, modifying, and discontinuing the medication line item.

12. The computer-enabled method of claim 11, further comprising:
displaying an interaction report for the medication line item by cross-reference data in the computer database including one of drug-to-drug interaction data, drug-to-laboratory interaction data, and drug-to-system of a body interaction data.

13. The computer-enabled method of claim 11, further comprising:
collecting patient and medication information for one or more patients in a long-term care facility from one of the data entry device and an EMR system into the computer database;

14. The computer-enabled method of claim 11, wherein said collecting data for the medication comprises collecting: a medication name, a strength, a unit, a source, and an indication.

15. The computer-enabled method of claim 14, wherein the indication comprises one of a first indication and a second indication, the first indication comprising at least one of a set of codes referring to the type of illness being treated and a system of a body for which the medication is intended, and the second indication comprising at least one of a set of ICD-9 codes.

16. The computer-enabled method of claim 11, further comprising:
moving the medication line item from the unreconciled medication section display to a reconciled medication section display.

17. The computer-enabled method of claim 16, further comprising:
displaying a hold on the medication line item while the medication line item is displayed in the reconciled medication section display; and
displaying a modification to the medication line item while the medication line item is displayed in the reconciled medication section display.

18. The computer-enabled method of claim 16, further comprising:
moving the medication line item from the reconciled medication section display to a discontinued medication section display.

19. The computer-enabled method of claim 11, further comprising:
displaying the medication line item with an unreconciled status on a patient note screen while not displaying the unreconciled medication section display.

20. The computer-enabled method of claim 11, further comprising:
displaying the medication line item with a discontinued status on the patient note screen while not displaying the discontinued medication section display.
